(19) United States
(12) Patent Application Publication
(10) Pub. No.: US 2008/0000527 A1
(43) Pub. Date: Jan. 3, 2008

(54) Apparatus and Method for Slow Transport of a Liquid Body

(75) Inventors: Zachary H. Ranstead, Pennsburg, PA (US); Edward A. Vollberg, Langhorne, PA (US)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(73) Assignee: STOUT, TACCONELLI & ASSOCIATES, INC., Pennsburg, PA (US)

(21) Appl. No.: 11/769,338

(22) Filed: Jun. 27, 2007

Related U.S. Application Data
(60) Provisional application No. 60/817,192, filed on Jun. 28, 2006.

(51) Int. Cl. F16K 31/12

(52) U.S. Cl. 137/2; 137/398

(57) ABSTRACT

A floating drain apparatus and method for maintaining base line flow rates and addressing problems associated with liquid runoff volume increases (e.g., storm water runoff) by transporting a portion of a liquid body through the apparatus which includes a submersible inlet vessel having openings for receiving the liquid body, an outlet hose having a regulating orifice and vent, and a buoyant device connected to the outlet hose such that the liquid body is slowly transferred from the vessel through the outlet hose.

### CROSS-REFERENCE TO RELATED APPLICATION

This application claims the benefit of U.S. Provisional Patent Application No. 60/817,192, filed Jun. 28, 2006.

### BACKGROUND OF THE INVENTION

The collection, transportation and delivery of liquids have received great attention for centuries. For example, since the earliest days, man has devised ways to move water from one location to a more desirous location to serve a variety of essential needs. The control of liquids has not however been limited to water but instead has also included chemicals, fuels, sewage, and the like, as well as mixtures thereof. Nevertheless, a prime example of liquid control is the collection, transportation and delivery of storm water for irrigation, drinking, bathing, washing and many other activities.

As land development activities, vegetation removal, soil compaction and the placement of impervious covers over land increase, the natural ability of soil to absorb and infiltrate water from a variety of sources decreases. Current methods for addressing problems caused by decreases in water absorption and infiltration primarily involve collection, detention and release of water runoff at a rate no greater than that of pre-development conditions.

Although the rate of runoff from a site can be controlled, it is often difficult to control the volume of water runoff. The cumulative effect of runoff volume increases on streams, rivers, ponds, lakes, impoundments, reservoirs and the like is often devastating, resulting in high water velocities, severe land erosion, loss of habitats, damage to property and, in some instances, loss of human life. Despite recent advances in water management theories and practices, there are relatively few methods for addressing the problems caused by increases in water runoff volume. Infiltration projects and designs for controlling water runoff have shown some promise in reducing runoff volume increases. However, traditional infiltration methods are not possible for all projects due to, for example, such limitations as seasonal high water tables and shallow bedrock. Other volume retention methods, such as green roofs and cisterns, are often not economically feasible or practical.

In addition to increases in runoff rates and volume, increases in runoff temperature are yet another adverse effect caused, in part, by land use practices. The natural ecosystem is sensitive to temperature increases as elevated water temperatures result in less dissolved oxygen in the water. This occurs when, for example, natural land cover is replaced with an impervious cover (e.g., asphalt) enabling the impervious cover to warm the water runoff.

A beneficial aspect of infiltration design is that it maintains cooler baseline water flow to, for example, streams and wetlands at rates similar to the infiltration rates of soil. However, when infiltration design is not possible or feasible, it is often difficult to provide an alternative design which performs as effectively in maintaining baseline water flow rates. For example, a standard water detention system includes an impoundment that receives runoff from various water sources. During a precipitation event, the impoundment partially fills with runoff, and subsequently is completely drained at a controlled rate through a riser structure. The riser or standpipe has a base orifice and larger openings higher on the structure for larger, less frequent runoff events. Due to the physical limitations associated with riser structures, the base orifice must typically be larger than 3 inches in diameter in order to prevent clogging due to artifacts and debris in the water. As a result, typical extended detention basins release nearly their entire volume in 24 to 48 hours. At the same time, stream levels are often already elevated due to a runoff response from the remainder of the watershed. Although discharge rates from typical extended detention basins are often significantly less than pre-development site infiltration conditions during small precipitation events, the timing of the outflow often causes more flow in the stream than before development, The result is an increase in stream velocities and erosion.

The basin discharge or release could be extended, and further reduced in a beneficial manner, if the riser orifice diameter was reduced to less than a few inches. However, a smaller orifice would be difficult to maintain as it would be submerged under several feet of water for a significant period of time. The use of screens to prevent debris from damaging the orifice or other parts of the riser has not proven to be effective. For example, a clogged screen could cause significant damage as a result of an unacceptable discharge or outflow rate increase if the basin has not completely dewatered from the previous runoff event.

Another disadvantage associated with the use of extended detention basins is that discharge or outflow rates are variable; that is, as the basin initially fills to its peak elevation, more head is built over the base orifice and therefore more runoff is released than at later times. Additionally, thermal impacts on streams are often not adequately addressed by normal extended detention basins.

For at least the foregoing reasons, extended detention basins do not effectively maintain base line flow rates, fully maximize water quality, and/or address runoff volume increases. Accordingly, there is a need for an apparatus and method for transporting a portion of a liquid body which maintains base line flow rates and addresses the problems set forth above, including those associated with runoff volume increases.

### SUMMARY OF THE INVENTION

This invention relates to the art of liquid level control and provides a floating drain apparatus and method for slowly transporting a portion of a liquid body, for example, a reservoir or storm water pond. In a particular application, the invention relates to the control of water runoff such that the negative impact caused by runoff volume increases from land use practices is reduced or eliminated for a majority of runoff events. The quality of the outflow is improved as cooler water is discharged from the apparatus of the invention. It is therefore an object of the invention to provide a cost-effective apparatus and method for maintaining base line flow rates and addressing the problems associated with runoff volume increases. Other objects and advantages of the invention will be more fully apparent from the following disclosure and appended claims.

### BRIEF DESCRIPTION OF THE DRAWINGS

FIG. 1 is a detailed profile view of an embodiment of the present invention;

FIG. 2 is a conceptual isometric view of the embodiment of FIG. 1 showing the apparatus of the present invention in a wet-pond application; and

FIG. 3 is a conceptual isometric view of another embodiment of the present invention showing more than one floating drain apparatus having more than one inlet vessel and outlet hose in a wet-pond application.

### DETAILED DESCRIPTION OF THE INVENTION

Certain terminology may be used in the following description for convenience only and is not considered to be limiting. The words “right,” “left,” “lower” and “upper” designate directions in the drawings to which reference is made. The terminology includes the words above specifically mentioned, derivatives thereof and words of similar import.

The present invention is directed to an apparatus and method for the control of liquids by employing a floating drain device for use with a variety of objects which contain liquid bodies including, but not limited to, pools, ponds, basins, underground detention systems, rivers, streams, lakes, impoundments and reservoirs. The words “liquid” and “liquids” are intended to be broadly defined and are therefore not limited to water but rather can also include chemicals, fuels, sewage, and the like, as well as mixtures thereof.

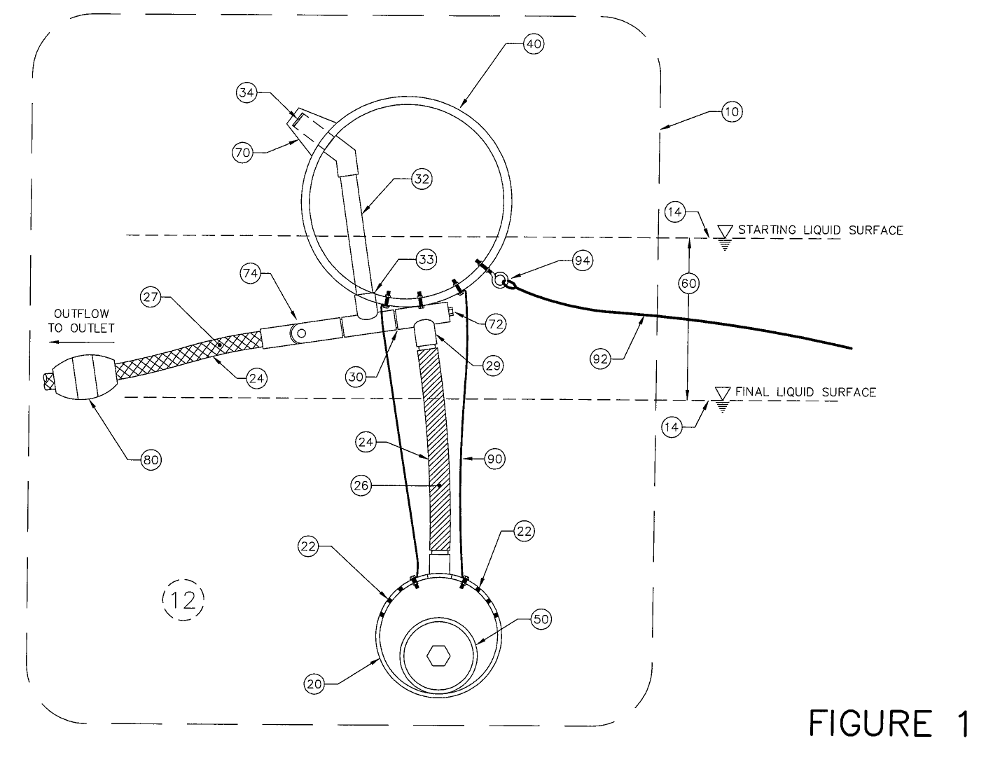

FIG. 1 shows an embodiment of the present invention. The invention is directed to a floating drain apparatus 10 for slowly transporting a portion of a liquid body 12. The words “slow” and “slowly” are intended to be broadly defined and are therefore not limited to a particular velocity, speed or rate. Preferably, however, the apparatus 10 is designed such that the control of liquids is such that the flow rate of the liquids is less than about 2 gallons per second.

The apparatus 10 includes a submersible inlet or intake vessel 20 having openings or perforations 22 for receiving a portion of the liquid body 12. The inlet vessel 20 is in communication with and at a higher internal pressure than an outlet hose 24. A differential pressure is established between the submerged inlet vessel 20 and the outlet hose 24 enabling the portion of the liquid body 12 to be siphoned or transported from the inlet vessel 20 to the outlet hose 24. The location of the inlet vessel 20 in relationship to the outlet hose 24 is such that a head pressure is maintained allowing the portion of the liquid body 12 to be transferred from the inlet vessel 20 toward the outlet hose 24 and, ultimately, to a desired location. Preferably a constant head pressure is maintained in the apparatus 10.

More specifically, FIG. 1 shows an embodiment of a floating drain apparatus 10 of the present invention having a submersible inlet vessel 20 containing a plurality of openings or perforations 22. Preferably, several rows of small perforations 22 are located substantially on a top portion of the intake vessel 20. The location of the perforations 22 helps prevent clogging of the intake vessel 20 from, for example, artifacts, debris and sediment. A plurality of perforations 22 also acts to reduce intake velocities at each individual perforation 22 such that clogging is significantly reduced. The inlet vessel 20 can be of various shapes and sizes but is preferably substantially cylindrically shaped. The inlet vessel is easily adapted, if necessary, to contain a ballast or weight 50 in order to submerge the inlet vessel 20 below a surface 14 of the liquid body 12. Preferably, the inlet vessel 20 is of substantial weight and density such that it is maintained at about a predetermined depth below the surface 14 of the liquid body 12 for collecting and withdrawing a portion of the liquid body from the body 12 regardless of level changes 60 in the liquid body 12. It is also preferred that the location of the intake vessel 20 below the liquid body surface 14 is adjustable such that the intake vessel 20 can be raised or lowered depending on conditions of the liquid body 12 and surrounding environment. It is further preferred that the inlet vessel 20 is located more than about a foot (12 inches) below the liquid body surface 14. More preferably, the intake vessel 20 is also located about 12 inches above the bottom of the liquid body 12. This preferred depth of the inlet vessel 20 effectively facilitates the collection and transport of a cooler portion of the liquid body 12 thereby reducing the possibility of thermal shock on, for example, a receiving river or watercourse (not shown). The preferred depth of the inlet vessel 20 also minimizes the possibility of drawing sediment, debris and other undesirable materials, which may be located toward the bottom of the liquid body 12, into the inlet vessel 20.

Still referring to FIG. 1, the inlet vessel 20 is in communication with the outlet hose 24. The outlet hose 24 can be of various sizes and materials of construction but is comprised of two or more sections of hose. While a lower section of hose 26, located closer to the inlet vessel 20, can be a rigid material of construction, it is preferred that all sections of the outlet hose 24 be of a flexible material. Preferably, the outlet hose 24 is of a rubber or neoprene material. The lower section of hose 26 is in communication with the inlet vessel 20 and conveys liquid drawn from a depth below the surface 14 of the liquid body 12. The lower section of hose 26 is also in communication with an upper section of hose 27. The lower section of hose 26 and the upper section of hose 27 are preferably connected by a connector 29.

The outlet hose 24 contains an orifice 30 that restricts flow and regulates the transport rate of the portion of the liquid body 12 as it transits the outlet hose 24. Preferably, the size of the orifice 30 is adjustable such that the flow of the portion of the liquid body 12 can be regulated. The orifice 30 can be various sizes but preferably ranges in size from about ¼ inch to about 4 inches in diameter. The ideal size of the orifice 30 will depend on several system variables including: the amount and size of debris and sediment in the liquid body 12; the storm water runoff calculation methodology (e.g., the Rational Method or the SCS Method); and the desired volume of the liquid body 12 to be removed/released (which may be related to the runoff calculation methodology). The size of the orifice 30 is proportional to the flow rate of the portion of the liquid body 12 that transits the outlet hose 24 such that, as the orifice size is increased, the flowrate increases. A person of ordinary skill in the art will appreciate that various types of orifices can be used effectively with the apparatus and method of the present invention.

A vent 32 establishes a downstream, atmospheric pressure of the apparatus 10 which creates a differential pressure between the inlet vessel 20 and the outlet hose 24 thereby facilitating flow of the portion of the liquid body 12 from the inlet vessel 20 to the outlet hose 24. The orifice 30 and vent 32 can be located at various positions along the length of the outlet hose 24. A first end 33 of the vent 32 is located in the vicinity of the orifice 30 in order to maintain an adequate discharge rate throughout the length of the outlet hose 24, and to help prevent a suction siphon which could undesirably increase discharge rates. Preferably, as shown in FIG. 1, the vent 32 is located downstream of the orifice 30. Most preferably, the orifice 30 is located within a few inches of the first end 33 of the vent 32. It is further preferred that the intake vessel 20 is located about two feet (24 inches) below the orifice 30.

A buoyant device 40, for example a float, is connected to the outlet hose 24 such that the outlet hose 24 is located above the submerged inlet vessel 20. The buoyant device 40 is preferably positioned over a relatively deep portion of the liquid body 12. The vent 32 is connected to or supported by the buoyant device 40 so that a second end 34 of the vent 32 is maintained above the surface 14 of the liquid body 12 to help ensure positive drainage. The vent 32 optionally contains a screen 70 for preventing anything from being inserted into the vent 32. Due to the orientation of the upper section of hose 27 near the water surface, low, approximately constant head conditions exist, resulting in a slow, nearly steady outflow rate of the portion of the liquid body 12.

As shown in FIG. 1, the connector 29 optionally contains an end cap 72 for allowing access to the outlet hose 24. It is also preferred that the outlet hose 24 contain pipe or tubular fittings or couplings 74, at least some of which rotate thereby providing the outlet hose 24 additional flexibility. It may also be necessary or desired for the outlet hose 24 to contain one or more floats 80 along the upper section of hose 27 to prevent sagging of the hose 27 and to maintain the hose 27 at a desired depth in relation to the surface 14 of the liquid body 12 so that a discharge rate is maintained through the outlet hose 24.

The inlet vessel 20 is optionally connected to the buoyant device 40 by safety lines or wires 90 to prevent the loss of the inlet vessel 24 in the event the inlet vessel 20 separates from the apparatus 10. Additionally, one or more restraining devices 92 may be necessary to maintain the position of the apparatus 10 within the liquid body 12. For example, in a wet pond application, the apparatus 10 is preferably tethered to the pond shore or floor with at least one restraining device 92 to restrain or maintain the approximate position of the apparatus 10 over a deep portion of the liquid body 12 during, for example, wind gusts and quick moving currents. The tension on the restraining device 92 is preferably adjustable and it is further preferred that the restraining device 92 design and position account for outside interferences such as moving equipment and vandalism. As shown in FIG. 1, the buoyant device 40 is connected to the restraining device 92 by a connector 94, such as an eye hook or a clasp.

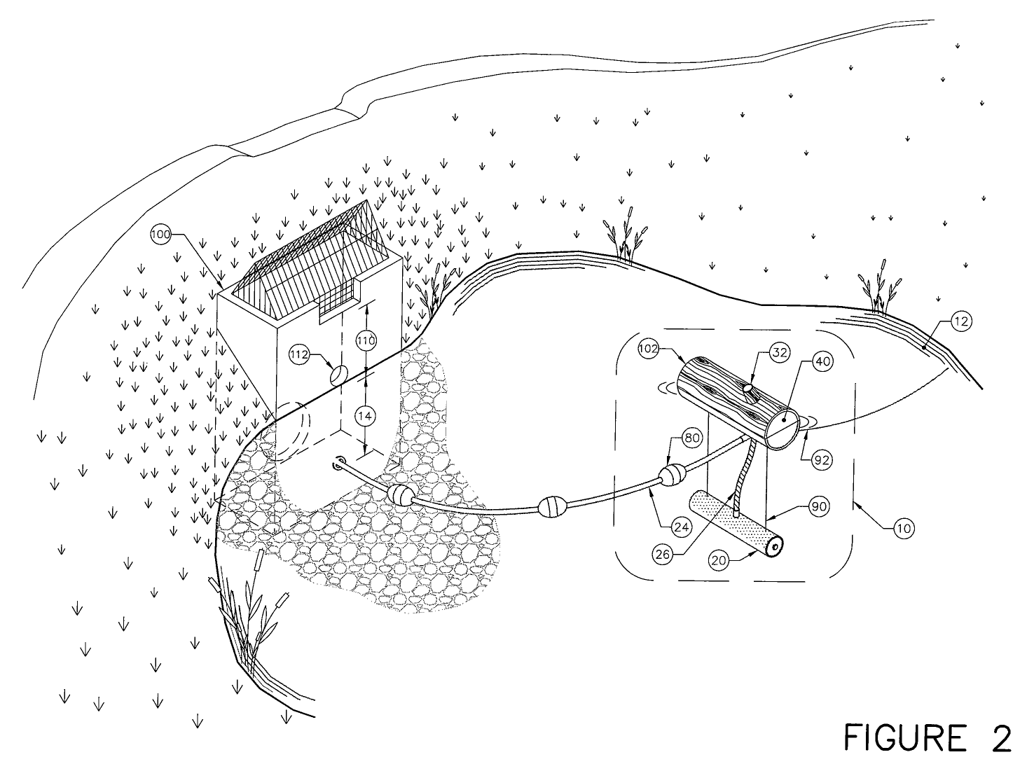

The apparatus 10 of the invention can easily be attached to, for example, a riser, outlet structure, detention pond or basin, or a liquid removal facility. For example, as shown in FIG. 2, a portion of the liquid body 12 can be transported from the inlet vessel 20 through the outlet hose 24 and eventually to, for example, a detention basin 100. The liquid body 12 could, for example, have capacity for additional runoff volume 110, above the volume portion typically transported by the apparatus 10. In order to mitigate the additional runoff volume 110 from larger, more infrequent runoff events, the detention basin 100 can contain one or more outlets 112. The outlets are typically significantly larger in size in comparison to the orifice 30. Additionally, as shown in FIG. 2, the buoyant device can, if desired, be fitted with an aesthetic cover 102 so that the buoyant device 40 can appear to be, for example, driftwood, a mock rock, or other more aesthetically appealing objects typically found in the environment.

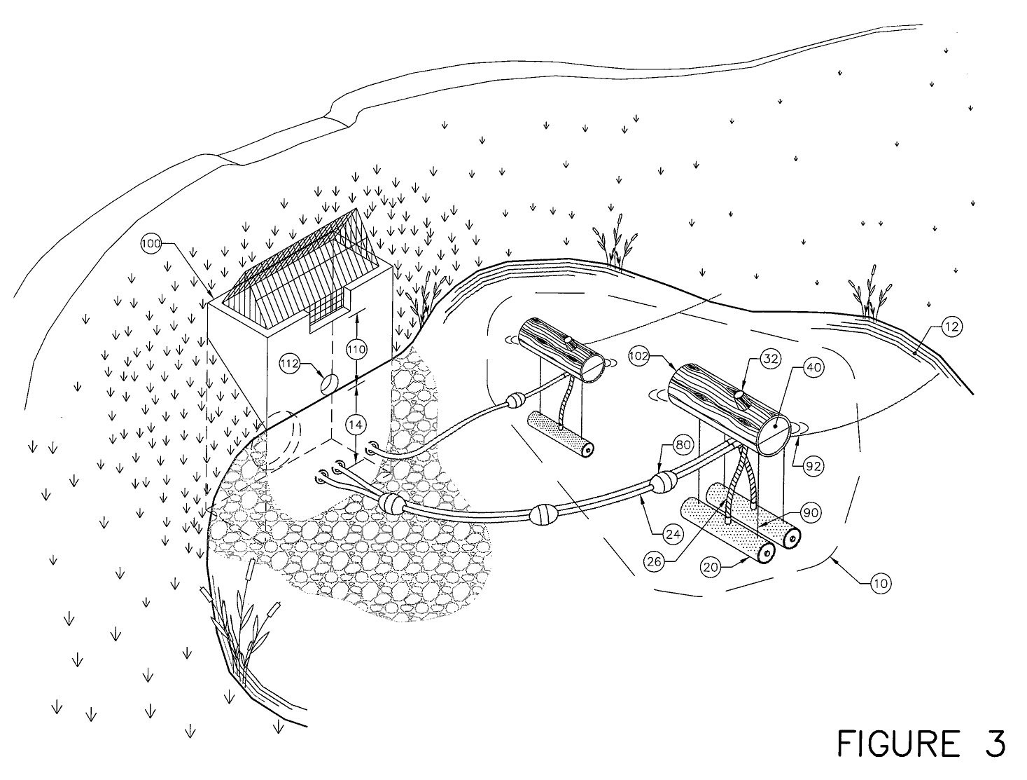

Referring now to FIG. 3, the apparatus 10 of the present invention can be easily adapted to include more than one inlet vessel 20 and/or more than one outlet hose 24 such that the additional vessels 20 and hoses 24 are connected to and/or suspended from about the bottom of at least one buoyant device 40. The number of inlet vessels 20 and outlet hoses 24 required is dependent on the hose size, orifice size, and the desired dewatering time of a determined volume. Preferably the desired dewatering time of a determined volume is about 7 to about 21 days. Also, if desired, more than one floating drain apparatus 10 of the present invention can be installed on the same liquid body 12.

A specific embodiment and application of the invention is directed to a storm water runoff. The apparatus 10 of the invention functions to slowly dewater a portion of the liquid body 12 caused by storm water runoff and can operate effectively in conjunction with other drainage systems. The portion of the liquid body 12 can be, for example, the pre- to post-development volumetric runoff increase from a precipitation event of a 2-year frequency. The apparatus 10 and method of the present invention enable an additional liquid volume, beyond that provided by a typical detention system base orifice, to be slowly and effectively transported such that the problems associated with detention systems are overcome. Such problems can be, for example, stream erosion from discharges from a large orifice device. For more frequent runoff events, which have less precipitation than a 2-year frequency event, the apparatus 10 enables another installed detention system to have a negligible outflow rate. Most preferably, the apparatus 10 enables a zero stream impact to be achieved for discharges associated with said volume portion. This portion of volume would be converted to gradual stream base flow. Thus, the apparatus 10 allows runoff from a developed site to be released in a manner which mimics a natural hydrologic regime.

The materials of construction of the apparatus of the present invention should be durable and include, but not be limited to, polymeric substances, metals, and those materials known or to be discovered in the art. Material considerations for the apparatus of the invention that a person of skill in the art must take into account include the effects of temperature extremes, photo-degradation, ice, corrosion, chemicals, solvents and other substances reasonably expected to have a deleterious effect on materials of construction.

The present invention also includes a method for slowly transporting a portion of a liquid body from a selected depth of the liquid body. The method includes installing an inlet vessel for collecting a portion of the liquid body; further installing an outlet hose, having a regulating orifice and a vent, such that outlet hose is in communication with the inlet vessel; connecting a buoyant device to the outlet hose such that the outlet hose is located above the inlet vessel when placed in the liquid body. The inlet vessel is preferably maintained at a predetermined depth below a surface of the liquid body for collecting the portion of the liquid body regardless of level changes in the liquid body. As shown in FIGS. 2 and 3, if desired, the method of the invention can also include delivering the portion of the liquid body to, for example, a riser, outlet structure, detention pond or basin, or a liquid removal facility, for further processing.

The apparatus 10 and method of the present invention enable an additional liquid volume, below that provided by a typical detention system base orifice, to be slowly and effectively transported such that the problems associated with detention systems are overcome. By slowly transporting this additional liquid volume over a period of weeks, base flow rates are better maintained. As a result, immediate runoff volume increases following, for example, a precipitation event of magnitude less than a 2-year frequency, will likely not be noticed by receiving risers or streams as the pond would have a negligible increase in outflow rate. Because the inlet vessel 20 is maintained below the liquid surface 14, cooler water is discharged thereby reducing thermal impact on streams while also improving water quality. The apparatus 10 and method of the present invention provide cost-efficient alternatives to other measures for addressing liquid runoff volume increases.

While the invention has been described with reference to specific embodiments thereof, it will be appreciated that numerous variations, modification, and embodiments are possible, and accordingly, all such variations, modifications, and embodiments are to be regarded as being within the spirit and scope of the invention. For example, FIGS. 2 and 3 show the apparatus 10 used in a wet pond. However, the apparatus 10 can be used effectively in, for example, an underground detention system to remove a variety of different liquids.

What is claimed is:

1. A floating drain apparatus for transporting a liquid body comprising:
at least one inlet vessel having a plurality of openings for receiving a portion of said liquid body;
at least one outlet hose comprising a regulating orifice and vent; and
a buoyant device connected to said outlet hose,
wherein said inlet vessel is in communication with and located below said outlet hose.

2. The floating drain apparatus of claim 1 wherein said inlet vessel is substantially cylindrically shaped.

3. The floating drain apparatus of claim 1 wherein said inlet vessel contains at least one weight.

4. The floating drain apparatus of claim 1 wherein said location of said inlet vessel is adjustable.

5. The floating drain apparatus of claim 1 wherein said inlet vessel is about two feet below said regulating orifice.

6. The floating drain apparatus of claim 1 wherein said inlet vessel is about one foot above a bottom of said liquid body.

7. The floating drain apparatus of claim 1 wherein said orifice diameter is about V₄ inch to about ¼ inches.

8. The floating drain apparatus of claim 7 wherein said orifice diameter is adjustable.

9. The floating drain apparatus of claim 1 further comprising at least one restraining device for restricting movement of said apparatus.

10. The floating drain apparatus of claim 1 wherein said buoyant device comprises an aesthetic cover.

11. The floating drain apparatus of claim 1 wherein a transport rate of said portion of said liquid body through said apparatus is less than about 2 gallons per second.

12. A method for slowly transporting a liquid body comprising the steps of:
a) installing an inlet vessel for collecting a portion of said liquid body;
b) further installing an outlet hose having a regulating orifice and a vent;
c) connecting a buoyant device to said outlet hose; and
d) inserting said inlet vessel, outlet hose and buoyant device in said liquid body,
wherein said outlet hose is in communication with and located above said inlet vessel.

13. The method of claim 12, wherein said inlet vessel is of substantial weight that said inlet vessel is maintained at about a predetermined depth below a surface of said liquid body.

14. The method of claim 12, further comprising delivering said portion of said body to at least one of a riser, an outlet structure, a detention pond, a basin, and a liquid removal facility.

15. The method of claim 12, further comprising repeating steps (a), (b), (c) and (d) in order to transport a larger portion of said liquid body.
